(19) United States
(12) Patent Application Publication
(10) Pub. No.: US 2004/0207723 A1
(43) Pub. Date: Oct. 21, 2004

(54) UI remoting with synchronized out-of-band media

(76) Inventors: Jeffrey Alan Davis, Snohmomish, WA (US); Inderpal Singh, Bellevue, WA (US)

Correspondence Address: SHOOK, HARDY & BACON L.L.P., 2555 GRAND BOULEVARD, KANSAS CITY, MO, 64108-2613, US

(21) Appl. No.: 10/413,846

(22) Filed: Apr. 15, 2003

(51) Int. Cl. H04N 7/14

(52) U.S. Cl. 348/14.04

(57) ABSTRACT

A method and system are provided for distributing a computing experience, which includes a user-interface component and one or more media components, to one or more endpoints via a communications network. The method includes communicating the user-interface component and the one or more media-experience components though separate communications channels instead of a single channel. The user-interface component is reunited and synchronized with the media-experience component at an endpoint where it can be remotely observed and controlled.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to computer software application programming and video rendering. More particularly, this invention relates to reproducing media-rich computing experiences across a computing network.

### BACKGROUND OF THE INVENTION

As general-purpose computing systems (computers) evolve into entertainment centerpieces, the functionality offered by operating systems continues to increase. Modern computer-program products are enabling computers to offer entertainment services previously reserved for the television, VCR, radio, and telephone. For example, a description of an exemplary user interface offering such advanced services is described in the nonprovisional application entitled “User Interface For Operating a Computer From a Distance,” Ser. No. 10/174,619, filed on Jun. 19, 2002, by Parker, et al., and commonly assigned to the assignee of the present invention, incorporated by reference herein.

That invention provides an interface for operating a computer from across a room as opposed to within a couple of feet. Such an invention conserves resources by enabling a computer to replace a stereo receiver, television, VCR, media player, and more.

With an Internet and/or cable-TV connection, a computer equipped with a such an interface can be used to watch television, record movies, and listen to radio programming by using a remote control from a distance. But these media experiences can potentially be reserved for the machine (monitor, TV, etc.) directly connected to the PC.

The current state of the art could be improved by extending a local computing experience that includes a media experience (such as streaming video or real-time TV) to remote endpoints. Consider a household that may have a single PC physically located in an office. Although this PC may be equipped to locally present a media experience in high quality, remote endpoints cannot currently (absent the present invention) present the same media experience(s) in high quality.

Historically, transmitting video from a computer through a local area network (LAN) to an endpoint involves an inefficient process that produces poor results. Watching on a remote device high-quality video (or some other media experience) that is stored on a local device has not been feasible. Two prior-art attempts for remoting media experiences exist.

Reproducing the computing experience requires recreating both the user-interface component and any media component of the computer experience. In a first prior-art attempt, a process begins by referencing a media source to gather the media component. The media component is demultiplexed or depacketized to separately decode the video and audio. A video renderer is then sourced with the decoded video along with the user-interface component to create a bitmap, which is then sent across a network. Even if this bitmap is attempted to be compressed prior to sending, the compression is typically a lossless compression and hence, the compression is not very high. That is, the compression ratio would be relatively low. This bitmap is then transferred across a network to an audio/visual (A/V) endpoint. A bitmap must be communicated across the network for each frame of video. This method is notoriously bandwidth intensive.

In a second prior-art attempt, a local file is completely transferred to a remote endpoint and then presented on the endpoint. But this attempted method requires the remote endpoint to have virtually the same processing capacity as the computer from which it was transferred. A user must wait for the entire file to be transferred before viewing it.

In a tenuously related application for distributing video, a conventional splitter is employed. A single source is amplified, split into many signals, and distributed to multiple endpoints. Some instantiations can include modulators that distribute video to certain TV channels and use IR blasters that allow commands to be received at the sourcing device. For each media-sourcing device, only a single media experience can be reproduced at a remote endpoint. Thus, if someone in a bedroom wanted to watch a DVD from a DVD player located in a family room, he or she could do so; but everyone else in the house would have to witness the same media experience (watch the same DVD movie) for that single device. This scheme has several other shortcomings.

First, this method merely distributes audio and video only instead of extending a media-rich computing experience to an endpoint. This is similar to distinguishing a computer from a VCR; or a computer from a DVD player. Modern computers receive Internet content, store audio, store videos, store pictures, play slideshows, and more. This distinction is nontrivial.

Second, only a single media experience can be viewed per source device. This is a waste of resources where the source device is a PC (or peripherally connected component) that could otherwise be capable of generating multiple entertainment sessions. Merely splitting video, although apparently similar in function, bears little resemblance to extending the functionality offered by a computer.

To conclude a nonexhaustive list of shortcomings, the A/V splitter approach does not allow the implementation of a digital rights management (DRM) scheme. DRM enables media distribution to be policed and limited. As copyright violations increase, DRM implementations become more important. Although DRM schemes do not need to be implemented in the present invention, it does allow for their application.

The present state of the art could be improved by providing a method and system that allows a computer experience, which includes a user-interface component and one or more media components, to be remoted or communicated across a network and recreated in high quality on a remote endpoint.

### SUMMARY OF THE INVENTION

The present invention generally relates to a method, system, and interface that facilitates high-quality remoting of a computing experience. The computer experience includes a user-interface and a media component, which may be audio, video, data, or a combination of the three. The present invention has several practical applications in the technical arts not limited to receiving at a client device multimedia data streams communicated from a remote device along with a user interface that allows, among other things, control over the multimedia presentation. Any situation that requires remote dissemination of bandwidth-intensive media experiences will benefit from the present invention.

With the present invention, a single computer can be used as a media hub to transmit to various physical locations desired media experiences retrievable by the single computer. Respective sessions of each media experience enable real-time observations of distinct computing experiences by various users. Each user can simultaneously receive different computing experiences.

Rather than a single channel, separate communications channels are employed to communicate the user-interface portion and the media component of a computing experience. A network-sending component transmits the media component through a first channel and a remoting server transmits the user interface. Both components are synchronized and then rendered on a desired display device.

### BRIEF DESCRIPTION OF THE SEVERAL VIEWS OF THE DRAWINGS

The present invention is described in detail below with reference to the attached drawing figures, wherein:

FIG. 1 is a block diagram of a computing-system environment suitable for use in implementing the present invention;

FIG. 2A is a block diagram illustrating a high-level overview of the functionality offered by the present invention;

FIG. 2B is a more detailed block diagram illustrating an exemplary embodiment of the present invention; and

FIG. 3 is a process-flow diagram depicting an embodiment of the present invention.

### DETAILED DESCRIPTION OF THE INVENTION

The present invention enables video and other media representations to be transmitted from a computing device across a network and received in high quality by one or more endpoints. An exemplary operating environment for the present invention is described below.

### Exemplary Operating Environment

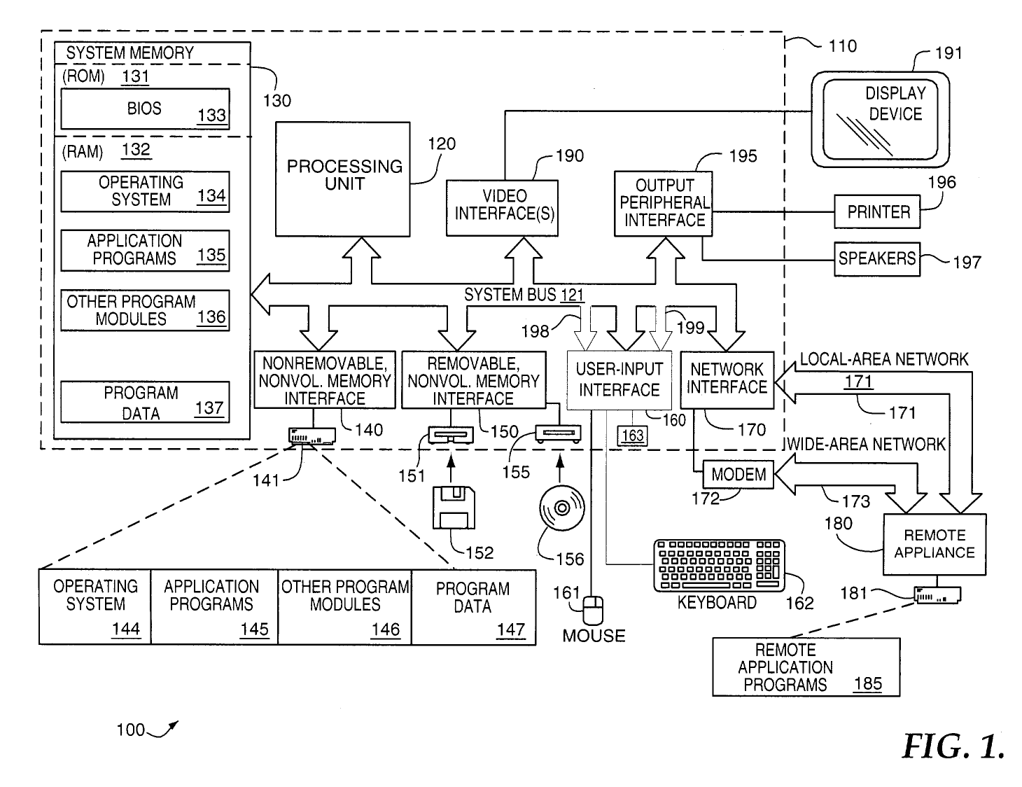

Referring to the drawings in general and initially to FIG. 1 in particular, wherein like reference numerals identify like components in the various figures, an exemplary operating environment for implementing the present invention is shown and designated generally as operating environment 100. The computing-system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. The invention may also be practiced in distributed-computing environments where tasks are performed by remote-processing devices that are linked through a communications network. In a distributed-computing environment, program modules may be located in both local and remote computer-storage media including memory-storage devices.

With reference to FIG. 1, an exemplary system 100 for implementing the invention includes a general purpose computing device in the form of a computer 110 including a processing unit 120, a system memory 130, and a system bus 121 that couples various system components including the system memory 130 to the processing unit 120.

Computer 110 typically includes a variety of computer-readable media. By way of example, and not limitation, computer-readable media may comprise computer-storage media and communication media. Examples of computer-storage media include, but are not limited to, Random Access Memory (RAM); Read Only Memory (ROM); Electronically Erasable Programmable Read-Only Memory (EEPROM); flash memory or other memory technology; CD-ROM, digital versatile discs (DVD) or other optical or holographic disc storage; magnetic cassettes, magnetic tape, magnetic disk storage or other magnetic storage devices; or any other medium that can be used to store desired information and be accessed by computer 110. The system memory 130 includes computer-storage media in the form of volatile and/or nonvolatile memory such as ROM 131 and RAM 132. A Basic Input/Output System 133 (BIOS), containing the basic routines that help to transfer information between elements within computer 110 (such as during start-up) is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer-storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical-disc drive 155 that reads from or writes to a removable, nonvolatile optical disc 156 such as a CD-ROM or other optical media. Other removable/nonremovable, volatile/nonvolatile computer-storage media that can be used in the exemplary operating environment include, but are not limited to, magnetic tape cassettes, flash memory units, digital versatile discs, digital video tape, solid state RAM, solid state ROM, and the like. The hard disk drive 141 is typically connected to the system bus 121 through a nonremovable memory interface such as interface 140. Magnetic disk drive 151 and optical dick drive 155 are typically connected to the system bus 121 by a removable memory interface, such as interface 150.

The drives and their associated computer-storage media discussed above and illustrated in FIG. 1 provide storage of computer-readable instructions, data structures, program modules and other data for computer 110. For example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs, and the like that are stored in RAM are portions of the corresponding systems, programs, or data read from hard disk drive 141, the portions varying in size and scope depending on the functions desired. Operating system 144, application programs 145, other program modules 146, and program data 147 are given different numbers here to illustrate that, at a minimum, they can be different copies. A user may enter commands and information into the computer 110 through input devices such as a keyboard 162; pointing device 161, commonly referred to as a mouse, trackball or touch pad; a wireless-input-reception component 163; or a wireless source such as a remote control. Other input devices (not shown) may include a microphone, joystick, game pad, satellite dish, scanner, or the like. These and other input devices are often connected to the processing unit 120 through a user-input interface 160 that is coupled to the system bus 121 but may be connected by other interface and bus structures, such as a parallel port, game port, IEEE 1394 port, or a universal serial bus (USB) 198, or infrared (IR) bus 199. As previously mentioned, input/output functions can be facilitated in a distributed manner via a communications network.

A display device 191 is also connected to the system bus 121 via an interface, such as a video interface 190. Display device 191 can be any device to display the output of computer 110 not limited to a monitor, an LCD screen, a TFT screen, a flat-panel display, a conventional television, or screen projector. In addition to the display device 191, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 10, although only a memory storage device 181 has been illustrated in FIG. 1. The logical connections depicted in FIG. 1 include a local-area network (LAN) 171 and a wide-area network (WAN) 173 but may also include other networks, such as connections to a metropolitan-area network (MAN), intranet, or the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. Modem 172 could be a cable modem, DSL modem, or other broadband device. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary, and other means of establishing a communications link between the computers may be used.

Although many other internal components of the computer 110 are not shown, those of ordinary skill in the art will appreciate that such components and the interconnections are well-known. For example, including various expansion cards such as television-tuner cards and network-interface cards within a computer 110 is conventional. Accordingly, additional details concerning the internal construction of the computer 110 need not be disclosed in connection with the present invention.

When the computer 110 is turned on or reset, the BIOS 133, which is stored in ROM 131, instructs the processing unit 120 to load the operating system, or necessary portion thereof, from the hard disk drive 141 into the RAM 132. Once the copied portion of the operating system, designated as operating system 144, is loaded into RAM 132, the processing unit 120 executes the operating-system code and causes the visual elements associated with the user interface of the operating system 134 to be displayed on the display device 191. Typically, when an application program 145 is opened by a user, the program code and relevant data are read from the hard disk drive 141 and the necessary portions are copied into RAM 132, the copied portion represented herein by reference numeral 135.

### Media-Experience Remoting

As previously mentioned, the present invention may be described in the general context of computer-useable instructions. Computer-useable instructions include functions, procedures, schemas, routines, code segments, and modules useable by one or more computers or other devices. The instructions cooperate with other code segments to transmit a media experience rapidly and in high quality to one or more remote endpoints.

A discussion follows with reference to a preferred embodiment to convey the spirit and functionality of the invention in a specific application. Upon reading this disclosure, a skilled artisan would appreciate alternative ways of effecting the same functionality and alternative applications of the present invention, all of which are contemplated within the scope of the claims.

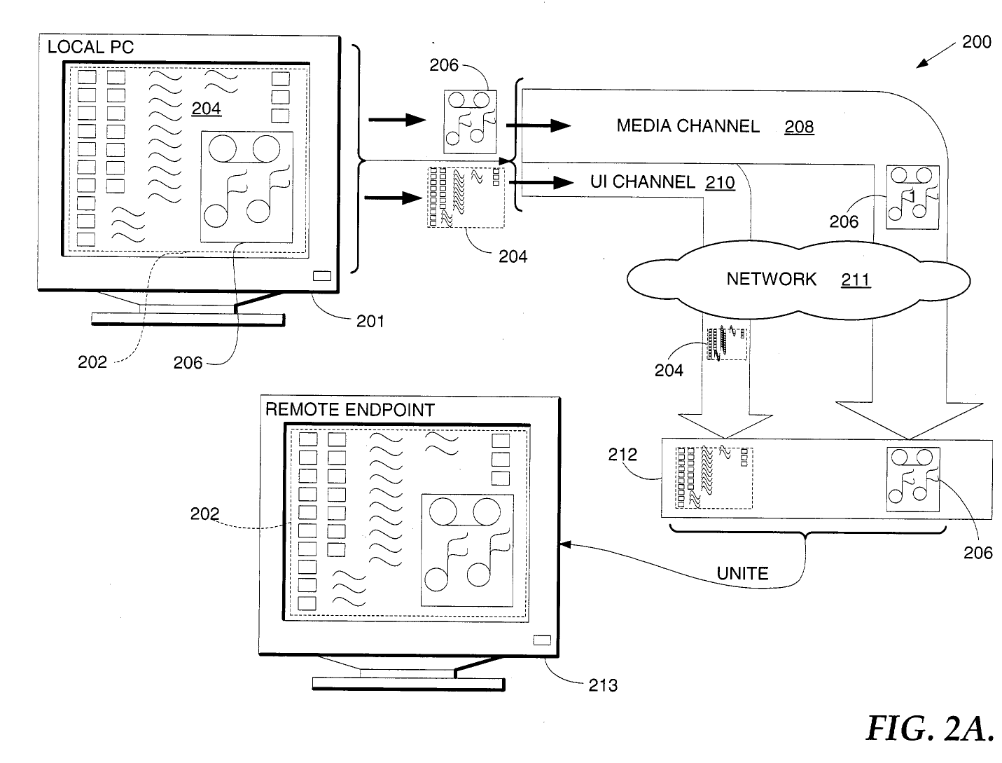

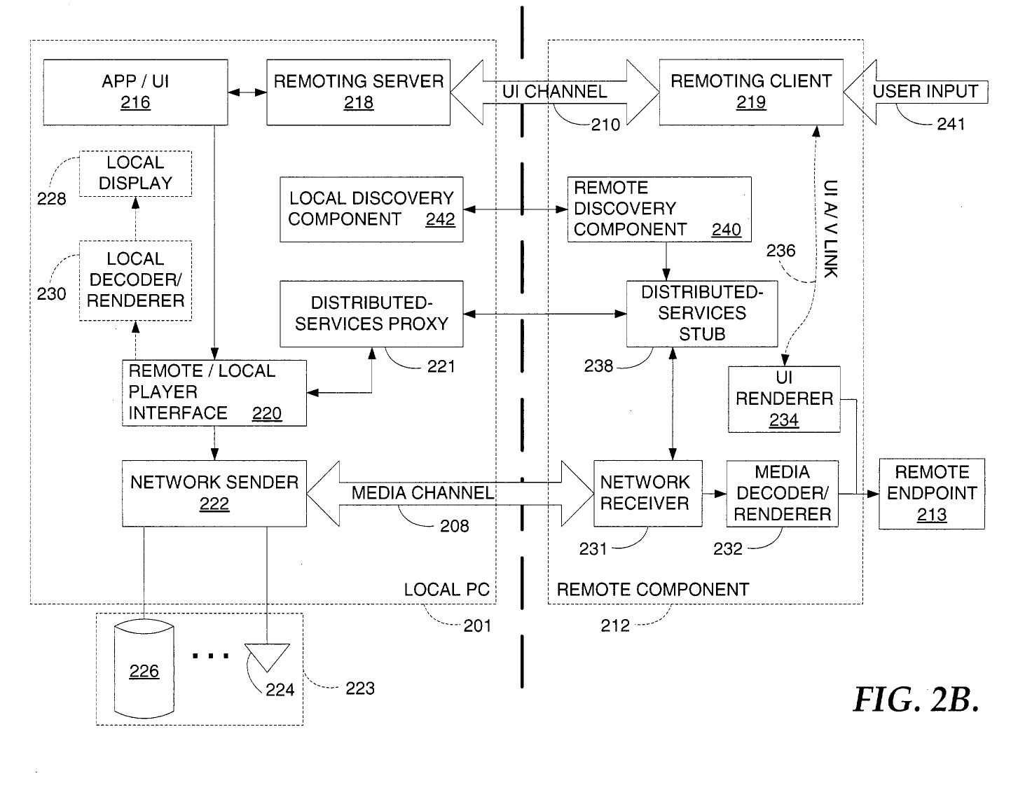

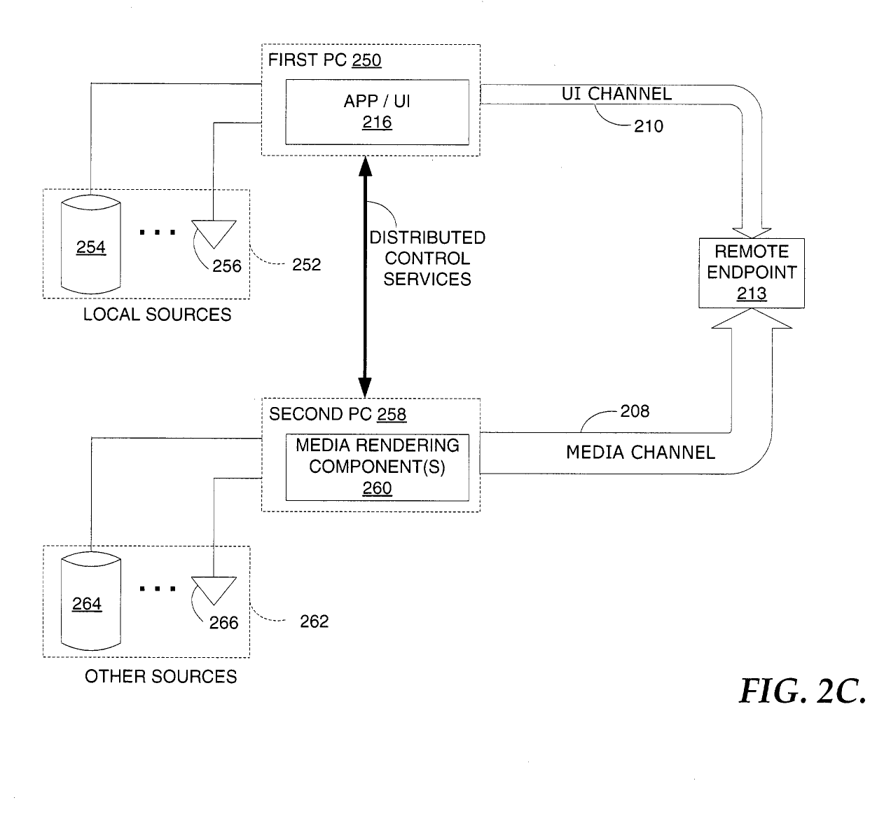

FIG. 2 provides a high-level overview of an exemplary operating environment 200 suitable for practicing the present invention. A local PC 201 depicts a computing experience 202, which includes a user-interface component 204 and a media component 206. To transmit the computing experience 202 in high quality, the user interface is communicated through a user-interface channel 210 and the media component(s) 206 are communicated through a media channel 208 via network 211. A remote component 212 receives the user-interface component 204 and the media component 206 through their respective channels. The media and user-interface component are composited to render the computing experience 202 on a remote endpoint 213.

Local PC 201 can be a conventional PC, such as computer 110, as well as a variety of other computing devices. Other exemplary computing devices include a notebook computer, a tablet PC, or a server. Local PC 201 can be any consumer-electronics device capable of rendering media component 206. As will be described in greater detail below, local PC 201 can be used in connection with components to remotely distribute media presentations. Using local PC 201 enables a DRM scheme to be applied to the distributed media presentations.

In one aspect, DRM secures and encrypts transmitted media to help prevent unauthorized copying. In another aspect, DRM includes protecting, describing, identifying, trading, monitoring, and/or tracking a variety of forms of media rights usages. DRM can be used to manage all rights, even beyond rights associated with permissions of digital-content distribution. An exemplary DRM implementation is described in the nonprovisional application entitled “Digital rights management operating system,” U.S. Pat. No. 6,330,670, filed on Dec. 11, 2001, by England, et al., and commonly assigned to the assignee of the present invention, incorporated by reference herein.

Computing experience 202, in a preferred embodiment, is a media experience that would be observed locally at PC 201. But computing experience 202 should not be construed as limited to a single instantiation. Rather, the present invention contemplates multiple computing experiences 202 that can each be instantiated and received by respective endpoints. Computing experience 202 includes both a user-interface component 204 and a media component 206.

User-interface component 204 includes graphics and images that typically compose a user interface. User-interface component 204 includes icons, host audio, background images and applications such as word-processing applications, spreadsheet applications, database applications, and so forth. Virtually any components that are not media components are part of user-interface component 204.

Media component 206 includes media-rich or bandwidth-intensive elements that compose a media event. The following is a nonexhaustive list of exemplary media components: a streaming media presentation, including a video and/or audio presentation; a television program, including a cable television (CATV), satellite, pay-per-view, or broadcast program; a digitally compressed media experience; a radio program; a recorded media event (sourced by a VCR, DVD player, CD player, Personal Video Recorder and the like); a real-time media event; and a camera feed.

Thus, a user with local PC 201 located in a home office could use that PC to watch a streaming video program from the Internet on a television (a first remote endpoint 213) in the family room. Moreover, using the same PC, a child could simultaneously watch on another television set (a second remote endpoint 213) a video stored on local PC 201.

Those skilled in the art will appreciate that these scenarios can be extended to a myriad of circumstances. A third user could simultaneously observe a camera feed inputted into local PC 201 that is remoted to a third remote endpoint 213. A fourth user could use local PC 201 to remote a fourth instantiation of computing experience 202 to watch a remoted television program on a monitor that does not have a TV tuner.

In each of the scenarios mentioned above, user-interface component 204 is presented on the respective remote endpoint 213 along with media component 206. This enables a remote user to remotely operate local PC 201. As will be explained in greater detail below, this enables a remote user to initiate commands such as stop, fast forward, and rewind as well as conventional computer commands that enable actions such as resizing replay windows and adjusting volume and picture quality.

User-interface channel 210 communicates user-interface component 204 to remote component 212. Terminal Server and Terminal Client Services, offered by Microsoft Corporation of Redmond, Wash., provide an exemplary user-interface channel 210. Any remotable protocol can be used to transmit data through user-interface channel 210. Exemplary protocols include the T-120 series protocol or HTML (hypertext markup language and its many variations).

Media channel 208 is separate from user-interface channel 210. Media channel 208 is used to transmit bandwidth-intensive experiences such as video and others listed above. Media component 206 provides a communications conduit for data to flow separate from user-interface component 204. Thus, the media component 206 is sent out of band with respect to the user-interface component, but synchronized. An exemplary protocol to transmit data through media component 206 includes, but is not limited to, the Transmission Control Protocol (TCP).

Network 211 can be any computing/communications network but is described in the context of a local area network (LAN). Today, LANs are offered in many varieties, including Ethernet, phone-wire networks, power-wire networks, and wireless networks. Wireless networks are not limited to radio and spread-spectrum networks and utilize protocols such as 802.11a, 802.11b, and 802.11g. An ordinary skilled artisan will readily appreciate these and other networks, all of which can be used in conjunction with the present invention.

FIG. 2B provides a more detailed illustration of an exemplary embodiment of the present invention. The local PC 201 is represented on the left portion of FIG. 2B and remote component 212 is represented on the right portion.

An application/user interface 216 is coupled to a remoting server 218. Application/user interface 216 could be an operating system's user interface, a word processor, a presentation-software package, a database program, and the like. As briefly mentioned above, application/user interface 216 includes those components that are not media components. Remoting server 218 is an application used to communicate user-interface component 204 through user-interface channel 210 to a remoting client 219, which can receive user input such as input from a keyboard, mouse, remote control, joystick, or other peripheral device. Although those skilled in the art will appreciate the litany of components that can be used as remoting server 218 and remoting client 219, in a preferred embodiment remoting server 218 includes a terminal server and remoting client 219 includes a version of the Remote Desktop Protocol (RDP) client, such as RDP 5.1 client.

Application/user interface 216 is also coupled to a remote/local player interface 220. This interface enables communication with certain components based on whether computing experience 202 will be run locally or remotely. Remote/local player interface 220 can include individual subcomponents such as a remote-player interface and a local-player interface. These two interfaces appear identical to application/user interface 216. For a local instantiation or session, a local-player interface communicates with a local renderer 230 that renders the computing experience 202 on a local display 228. For remote sessions, a remote-player interface is coupled to a network sender 222, which receives one or more media components 206 from a media source 223.

Media source 223 can be any source, local or communicatively coupled to local PC 201, that provides access to one or more media components 206. A storage device 226 such as a hard drive or tape device could be a media source. A TV tuner 224 could also provide media component 206 and thereby be a media source 223. Depicting even a large portion of devices that could provide a media source is not feasible. Those skilled in the relevant art will appreciate the abundance of alternative media sources, not limited to an Internet connection, a DVD player, a VCR player, a personal video recorder (PVR), a CD player, a digital-audio player, a camcorder, and/or a gaming device.

Remote/local player interface 220 is coupled to a distributed-services proxy 221. Those skilled in the art will appreciate the programming strategy of pairing a proxy with a stub to effect desired functionality. Here, distributed-services proxy 221 provides transport control functions such as stop, pause, play, fast forward, rewind, volume up, volume down, etc., to be remotely received and processed.

Moreover, the present invention facilitates video/graphics compositing. Beyond transport control operations, the present invention renders accurate video geometry; facilitates alpha blending, including blending one or more graphics components with one or more video components; accurately mixes audio, including coordinating host audio with audio from the one or more media components.

Network sender 222 sends the media component 206 through media channel 208 to a network receiver 231. Network receiver 231 receives the data communicated through media channel 208. Both network sender 222 and network receiver 231 are conventional in nature and their implementation would be understood by one skilled in the relevant art. Network receiver 231 passes the data on to a media decoder/renderer 232.

Media decoder/renderer 232 decodes and renders media component 206. Media decoder/renderer 232 can decode and render the different types of media experiences mentioned above including video, audio, and data. A UI renderer 234 renders user-interface component 204 as well as host audio via a UI A/V link 236. Remote component 212 unites media component 206 with user-interface component 204 for presentation on remote endpoint 213.

Remote component 212 also includes a distributed-services stub 238 and a remote-discovery component 240. The distributed-services stub 238 relays transport control commands (described above) to its complementary distributed-services proxy 221, thereby allowing a remote user to control the media component 206 being remoted from local PC 201.

Remote-discovery component 240 is associated with a local-discovery component 242. Together, these two components help facilitate communication between remote component 212 and local PC 201. Remote-discovery component 240 announces the presence of remote component 212 on network 211. Local-discovery component 242 acknowledges the announcement made by remote-discovery component 240—or otherwise senses the presence of remote component 212—and the functional aspects of remote component 212 can be communicated to local PC 201.

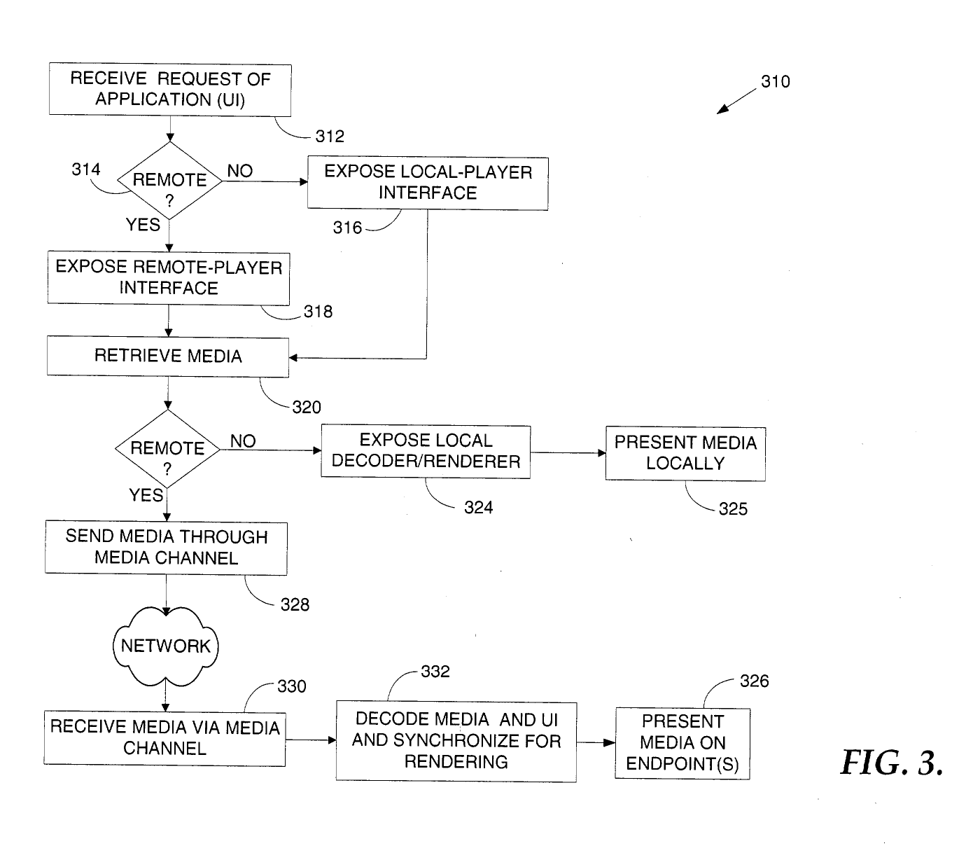

FIG. 3 depicts in flowchart form a preferred process carried out by the present invention and is referenced generally by the numeral 310. One should not interpret FIG. 3 as dictating a single order of the steps illustrated therein. An ordinary skill artisan will appreciate alternatives to the preferred embodiment, which are contemplated within the scope of the present invention.

A request is received to instantiate a session at a step 312. As previously described, multiple sessions can be instantiated each with a respective user-interface component 204 and media component 206. A determination is made at a step 314 as to whether this session is a remote session or a local session. A local session would be observed locally at local PC 201. A remote session will ultimately be observed at a remote media endpoint 213.

If the session is not to be a remote session, then a local-player interface is exposed at a step 316 to communicate with a local display device. The local-player interface processes remote transport-control commands such as play, stop, and fast forward and renders the computing experience 202 on local display 228. But if this particular session is to be a remote session, the one or more remote-player interfaces are exposed at a step 318. The local-player interface and the remote-player interface appear substantially identical to the application/user interface 216. The remote-player interface enables processing of remote transport-control commands so as to not interfere with local computing experiences or sister remote experiences.

One or more media experiences are retrieved from media source 223 at a step 320. Media source 223 need not be part of local PC 201, only transmittable to remote endpoint 213. For example, turning briefly to FIG. 2C, it can be readily seen that

the media channel can be sourced from a secondary computing device or third party source. No restriction is imposed upon the media channel 208 that it be coupled to the same PC that is rendering the UI. As shown, FIG. 2C depicts a first PC 250 having a application/user interface 216. A set of local media sources 252 can include a wide array of source devices as mentioned above (DVD player, CD player, VHS player, streaming media via the Internet). Two illustrative local media sources 252 are shown: a local storage device 254 and a local tuner 256.

A set of distributed control services are in communication with first PC 250 and a second PC 258, which can also take the form of a variety of computing devices and should not be limited to a mere conventional PC. The distributed control services are similar in nature to those previously mentioned above. In this embodiment, one or more media-rendering components 260 are located on second PC 258. Thus, the media-rendering component(s) 260 do not need to be located on the same PC as is the application/user interface 216. A separate set of media sources 262, similar in nature to those previously mentioned, is coupled to second PC 258. It should also be understood that these separate media sources 262 need not be locally coupled to second PC 258. These sources 262 can be coupled remotely to second PC 258 through a network.

Recapitulating this illustration, user interface 216 resides on a first PC 250 while media-rendering components 260 reside on a second PC 258. User interface 216 will be used to control playback of media events provided by second PC 258 at remote endpoint 213. User interface will be communicated to remote endpoint 213 via UI channel 210 and the media components will be transferred to remote endpoint 213 via media channel 208. Those skilled in the art will appreciate still other applications of the present invention that do not depart from the scope of the claims below.

Returning now to the flow diagram of FIG. 3 at a step 324, if the session instance is not a remote session, processing continues to local decoder/renderer 230. The media component 206 and user-interface component 204 can then be used to recreate computing experience 202 on local display 228 at a step 325.

If this session is a remote session, the media component 206 is sent through media channel 208 via network 211 at a step 328. The media component 206 is received by network receiver 231 at a step 330. The media component 206 is decoded and the user-interface component 204 is synchronized with the media component 206 for rendering at a step 332. The rendered computing experience 202 can be presented on one of the remote endpoints 213 at a step 326.

As can be understood, the present invention described herein enables media experiences to be remoted in high quality along with their respective user interfaces. The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well-adapted to attain the ends set forth above, together with other advantages which are obvious and inherent to the system and method. It will be understood that certain features and subcombinations are of utility and may be employed without reference to other features and subcombinations. This is contemplated and within the scope of the claims.

The invention claimed is:

1. One or more computer-readable media having computer-readable instructions embodied thereon for instantiating one or more instances of a computing experience from a first computing device on one or more remote endpoints, wherein the computing experience includes a user-interface component and one or more media components, comprising:
instructions that distinguish the user-interface component from the one or more media components;
instructions that communicate the user-interface component through a first communications channel; and
instructions that communicate the one or more media components though a second communications channel to the one or more remote endpoints;
whereby the user-interface component can be united with the one or more media components to recreate the computing experience on the remote endpoint.

2. The media of claim 1, wherein the one or more media components include at least one selection from the following:
a streaming media presentation, including a video and/or audio presentation;
a television program, including a cable television (CATV), satellite, pay-per-view, or broadcast program;
a digitally compressed media experience;
a radio program;
a recorded media event;
a real-time media event; and
a camera feed.

3. The media of claim 2, wherein the instructions that communicate the user-interface component through a first communications channel include instructions to receive event-control commands that control presentation attributes of the computing experience, wherein the event-control commands include one or more of the following:
a command to stop the media event;
a command to pause the media event;
a command to rewind playback of the media event;
a command to fast forward playback of the media event;
a command to adjust a picture quality of the media event;
a command to adjust the sound of the media event;
a command to change the focus of the media event;
a command to select a file to view; and
a command to change a channel.

4. The media of claim 3, wherein the one or more remote endpoints include one or more selections from the following: a monitor, a television, a personal data assistant (PDA), a consumer-electronics device, and a smart-screen device.

5. The media of claim 4, wherein instructions that communicate the one or more media components though a second communications channel include instructions that implement a digital rights management (DRM) scheme on the one or more media components.

6. A method for distributing a computing experience comprising a user-interface component and one or more media components to one or more endpoints via a communications network, the method comprising:
providing a first communications channel to communicate the user interface to the one or more endpoints; and
providing a second communications channel to communicate the media experience to the one or more endpoints.

7. The method of claim 6, further comprising:
communicating the user-interface component and the one or more media-experience components respectively though the first and second communications channels to the one or more endpoints; and
reuniting the user-interface component with the media-experience component at the one or more endpoints; whereby the computing experience can be remotely observed on the one or more endpoints.

8. The method of claim 7, wherein the one or more media components include at least one selection from the following:
a streaming media presentation, including a video and/or audio presentation;
a television program, including a cable television (CATV), satellite, pay-per-view, or broadcast program;
a digitally compressed media experience;
a radio program;
a recorded media event;
a real-time media event; and
a camera feed.

9. The method of claim 8, where the one or more endpoints include one or more selections from the following: a monitor, a television, a personal data assistant (PDA), a consumer-electronics device, and a smart-screen device.

10. The method of claim 9, wherein the first communications channel is a bi-directional communications channel that depicts the user interface and receives event-control commands, which includes one or more of the following commands: stop, pause, fast forward, rewind, adjust volume, adjust picture attributes, adjust channel, select a file for playback; and modify a window position of the media component.

11. The method of claim 10, wherein providing the first communications channel includes communicating host audio sounds to the one or more endpoints.

12. A computer-readable medium having computer-useable instructions embodied thereon for executing the method of claim 6.

13. One or more computer-readable media having computer-readable instructions embodied thereon for performing a method of presenting an instance of a computing experience on one or more remote endpoints received from a first computing device, wherein the computing experience includes a user-interface component and one or more media components, the method comprising:
receiving the user-interface component through a first communications channel;
receiving the one or more media components through a second communications channel; and
recreating the computing experience from the user-interface component and the one or more media components, whereby the computing experience can be presented on the one or more of the remote endpoints.

14. The media of claim 13, wherein the one or more media components include at least one selection from the following:
a streaming media presentation, including a video and/or audio presentation;
a television program, including a cable television (CATV), satellite, pay-per-view, or broadcast program;
a digitally compressed media experience;
a radio program;
a recorded media event;
a real-time media event; and
a camera feed.

15. The media of claim 14, wherein recreating the computing experience includes rendering a composite stream from the user-interface component and the media components(s) to the endpoint.

16. The media of claim 15, further comprising receiving user input to manipulate the computing experience.

17. The media of claim 16, wherein the user-input commands include commands received from a computer peripheral device.

18. The media of claim 13, wherein recreating the computing experience includes synchronizing the user-interface component with the one or more media components.

19. The media of claim 18, wherein synchronizing the user-interface component with the one or more media components includes one or more of the following operations:
rendering accurate video geometry;
facilitating alpha blending, including blending one or more graphics components with one or more video components; and
mixing audio, including coordinating host audio with audio from the one or more media components.

20. A computing device for communicating one or more instances of a computing experience to one or more remote components communicatively coupled to the computing device by a network, wherein the computing experience includes a user-interface and one or more media experiences, the computing device comprising:
a user-interface-transceiving component that communicates the user-interface and associated commands to and from the one or more remote devices though a first communications channel;
a discovery component that recognizes the presence of the one or more remote components; and
a network sending component that communicates the one or more multimedia experiences to the one or more remote components through a second communications channel.

21. The computing device of claim 20, wherein associated commands include user-input commands.

22. The computing device of claim 21, wherein the user-input commands are communicated by a peripheral component, wherein the peripheral component includes at least one selection from the following: a mouse, a keyboard, a remote control, a joy stick, a pointing device, and a stylus.

23. The computing device of claim 22, wherein the user-input commands include one or more of the following commands: stop, pause, fast forward, rewind, adjust volume, picture-attribute adjustments, channel changing, file selection, and window-modification commands.

24. The computing device of claim 23, wherein communicating one or more instances of a computing experience includes communicating a first computing experience to a first endpoint while concurrently communicating a second computing experience to a second endpoint.

25. The computing device of claim 24, wherein the first and second endpoints include one or more selections from the following: a monitor, a television, a personal data assistant (PDA), a consumer-electronics device, a personal computing device, and a smart-screen device.

26. A method for presenting on a media endpoint a first computing experience received from one or more communicatively coupled computing device(s), wherein the first computing experience includes a first user-interface component and a first set of one or more media experiences, comprising:
receiving a request to initiate a first remoting session, wherein the first remoting session includes the first user-interface component and the first set of one or more media experiences;
retrieving the first set of one or more media experiences from one or more media sources;
communicating the first user-interface through a first communications channel;
communicating the first set of one or more media experiences through a second communications channel; and
synchronizing the first user-interface component with the first set of one or more media experiences, whereby the computing experience can be rendered on the media endpoint.

27. The method of claim 26, wherein the first user-interface component resides on a first computing device and the first set of one or more media experiences reside on a second computing device.

28. The method of claim 27, wherein the first set of one or more media experiences includes one or more selections from the following:
a streaming media presentation, including a video and/or audio presentation;
a television program, including a cable television (CATV), satellite, pay-per-view, or broadcast program;
a digitally compressed media experience;
a radio program;
a recorded media event;
a real-time media event; and
a camera feed.

29. The method of claim 28, further comprising receiving a second request to initiate a second remoting session, wherein the second remoting session includes a second user-interface component and a second set of one or more media experiences.

30. The method of claim 29, further comprising instantiating the second session whereby the computing experience can be rendered on a second media endpoint.
